(19) United States
(12) Patent Application Publication
(10) Pub. No.: US 2013/0129592 A1
(43) Pub. Date: May 23, 2013

(54) YTTRIUM HYDROXYCARBONATE MODIFIED WITH HETEROGENEOUS METAL, METHOD OF PREPARING THE SAME, AND ADSORBENT AND FILTER DEVICE INCLUDING THE SAME

(71) Applicants: Hyun Seok Kim, Seoul (KR); Hyo Rang Kang, Anyang-si (KR); Chang Hyun Kim, Seoul (KR); Ho Jung Yang, Suwon-si (KR); Joo Wook Lee, Seoul (KR); Jae Eun Kim, Hwaseong-Si (KR); Kyoung-Woong Kim, Gwangju (KR); Ju-Yong Kim, Gwangju (KR); Sunbaek Bang, Gwangju (KR); Sang-Ho Lee, Gwangju (KR)

(72) Inventors: Hyun Seok Kim, Seoul (KR); Hyo Rang Kang, Anyang-si (KR); Chang Hyun Kim, Seoul (KR); Ho Jung Yang, Suwon-si (KR); Joo Wook Lee, Seoul (KR); Jae Eun Kim, Hwaseong-Si (KR); Kyoung-Woong Kim, Gwangju (KR); Ju-Yong Kim, Gwangju (KR); Sunbaek Bang, Gwangju (KR); Sang-Ho Lee, Gwangju (KR)

(73) Assignees: GWANGJU INSTITUTE OF SCIENCE AND TECHNOLOGY, Buk-gu (KR); SAMSUNG ELECTRONICS CO., LTD., Suwon-si (KR)

(21) Appl. No.: 13/449,744

(22) Filed: Apr. 18, 2012

(30) Foreign Application Priority Data
Nov. 22, 2011 (KR) 10-2011-0122370

(51) Int. Cl. C01F 17/00

(52) U.S. Cl. 423/263

(57) ABSTRACT

Example embodiments relate to a yttrium hydroxycarbonate modified with a heterogeneous metal, a method of preparing the same, an adsorbent for a heavy metal including the same, and a filter device including the same. The modified yttrium hydroxycarbonate may have a pore size distribution with a pore diameter peak of less than or equal to 10 nm.

### CROSS-REFERENCE TO RELATED APPLICATION

This application claims priority under 35 U.S.C. §119 to Korean Patent Application No. 10-2011-0122370, filed in the Korean Intellectual Property Office on Nov. 22, 2011, the entire contents of which are incorporated herein by reference.

### BACKGROUND

1. Field

Example embodiments relate to yttrium hydroxycarbonates modified with a heterogeneous metal, a method of preparing the same, and an adsorbent and a filter device including the same.

2. Description of the Related Art

The demand for heavy metals has increased with industrialization and economic growth. Many heavy metals not only have a variety of adverse influences on the human body, but also serve as serious pollutants to the environment (e.g., rivers and soil).

Water pollution through heavy metal discharge has been a global problem. Hazardous metal elements that have adverse effects on the human body and the ecosystem include arsenic (As), chromium (Cr), copper (Cu), lead (Pb), mercury (Pb), manganese (Mn), cadmium (Cd), nickel (Ni), and the like. For example, arsenic (As) is poisonous to the human body, and arsenic in rocks or underground geological stratum may be naturally dissolved in underground water. Conventional adsorbents formed of alumina, granular ferric hydroxide (GFH), and ferric oxides have been used as arsenic-removing filters. However, the adsorption capacity of conventional adsorbents is relatively limited.

### SUMMARY

Various embodiments of the disclosure relate to yttrium hydroxycarbonates modified with a heterogeneous metal and exhibiting improved heavy metal adsorption/removal performance.

Various embodiments of the disclosure relate to an adsorbent for adsorbing a heavy metal. The adsorbent may include a yttrium hydroxycarbonate modified with a heterogeneous metal.

Various embodiments of the disclosure relate to methods for preparing yttrium hydroxycarbonates modified with a heterogeneous metal.

Various embodiments of the disclosure relate to a filter device including a yttrium hydroxycarbonate modified with a heterogeneous metal.

According to a non-limiting embodiment of the disclosure, a yttrium hydroxycarbonate modified with a heterogeneous metal may include a structural framework and the heterogeneous metal within the structural framework. The structural framework may define a plurality of pores therein. A size distribution of the plurality of pores may have a peak of less than or equal to about 10 nm. The structural framework may be formed of at least yttrium atoms, oxygen atoms, and carbon atoms. The heterogeneous metal is a metal other than yttrium.

The yttrium hydroxycarbonate modified with a heterogeneous metal may have a pore size distribution having a peak of about 1 nm to about 7 nm.

The yttrium hydroxycarbonate modified with a heterogeneous metal may have a specific surface area of about 20 m²/g to about 260 m²/g.

The yttrium hydroxycarbonate modified with a heterogeneous metal may have a pore volume of about 0.1 cc/g to about 0.7 cc/g. The heterogeneous metal is a metal other than yttrium (Y) and may be selected from the group consisting of a transition element, a rare earth element, an alkali metal, an alkaline-earth metal, a Group 14 element (IUPAC periodic table), and a combination thereof. The heterogeneous may also be a Period 4 metal.

The transition element may be selected from the group consisting of titanium (Ti), vanadium (V), manganese (Mn), chromium (Cr), iron (Fe), cobalt (Co), nickel (Ni), and a combination thereof. The alkali metal and alkaline-earth metal may be selected from the group consisting of calcium (Ca), magnesium (Mg), and a combination thereof. The Group 14 element may be silicon (Si). The heterogeneous metal may be included in an amount of about 0.1 wt % to about 20 wt % based on the total amount of the yttrium hydroxycarbonate modified with a heterogeneous metal. According to a non-limiting embodiment, the heterogeneous metal may be included in an amount of about 0.5 wt % to about 12.5 wt % based on the total amount of the yttrium hydroxycarbonate modified with a heterogeneous metal.

The heterogeneous metal may exist in a form of a heterogeneous metal oxide (MOₓ) in a structure of yttrium hydroxycarbonate, where M denotes a heterogeneous metal and x is determined based on a valence of M.

The yttrium hydroxycarbonate modified with a heterogeneous metal may have a shapeless structure. For instance, the shapeless structure may be irregular and unsymmetrical. The shapeless structure may include particles having an average particle diameter of about 10 nm to about 30 nm. The shapeless structure may include pores having an average pore size of about 5 nm to about 200 nm. According to another non-limiting embodiment of the disclosure, an adsorbent for a heavy metal may include the yttrium hydroxycarbonate modified with a heterogeneous metal. The adsorbent for a heavy metal may be an arsenic adsorbent. The adsorbent for a heavy metal (e.g., As) may have a heavy metal adsorption capacity of greater than or equal to about 250 mg/g.

According to yet another non-limiting embodiment of the disclosure, a method for preparing the yttrium hydroxycarbonate modified with a heterogeneous metal may include preparing an aqueous solution containing a yttrium-containing salt and a heterogeneous metal-containing salt; preparing a mixture by adding urea to the aqueous solution; controlling pH of the mixture to about 6 to about 8 to obtain a precipitate; and drying the precipitate.

In the heterogeneous metal-containing salt, the heterogeneous metal is a metal other than yttrium (Y). The heterogeneous metal-containing salt may include a heterogeneous metal that is selected from the group consisting of a transition element, a rare earth element, an alkali metal, an alkaline-earth metal, a Group 14 element, and a combination thereof.

The transition element may be selected from the group consisting of titanium (Ti), vanadium (V), manganese (Mn), chromium (Cr), iron (Fe), cobalt (Co), nickel (Ni), and a combination thereof. The alkali metal and the alkaline-earth metal may be selected from the group consisting of calcium (Ca), magnesium (Mg), and a combination thereof. The Group 14 element may be silicon (Si).

According to still another non-limiting embodiment of the disclosure, a filter device may include the yttrium hydroxycarbonate modified with a heterogeneous metal as an adsorbent for a heavy metal.

### BRIEF DESCRIPTION OF THE DRAWINGS

FIG. 1 is a schematic diagram of a filter device according to a non-limiting embodiment of the disclosure.

FIGS. 2 and 3 are transmission electron microscopic (TEM) photographs of Y(OH)CO₃ prepared according to Comparative Example 1 and Ti-modified Y(OH)CO₃ prepared according to Example 2.

FIG. 4 is a graph illustrating the analyses of pore structures of the Y(OH)CO₃ prepared according to Comparative Example 1, TiO₂ (anatase) prepared according to Comparative Example 2, and Ti-modified Y(OH)CO₃ prepared according to Examples 1 and 2.

### DETAILED DESCRIPTION

Example embodiments will be described more fully hereinafter with reference to the accompanying drawings. The embodiments may, however, be embodied in many different forms and should not be construed as limited to the ones set forth herein.

In the drawings, the thickness of the layers, films, panels, regions, etc., may have been exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, the term “combination thereof” may refer to a mixture, a stacked structure, an alloy, and the like.

As used herein, the term “heterogeneous metal” may refer to a metal or a semi-metal (other than yttrium) that is capable of modifying a hydroxycarbonate.

Hereafter, yttrium hydroxycarbonates modified with heterogeneous metals and an adsorbent for a heavy metal including the modified yttrium hydroxycarbonates are described in further detail. A modified yttrium hydroxcarbonate may include a structural framework and one or more heterogeneous metals within the structural framework. The structural framework defines a plurality of pores therein and is formed of at least yttrium atoms, oxygen atoms, and carbon atoms. The heterogeneous metal may be bonded to an oxygen atom of the structural framework.

The pore size distribution of a yttrium hydroxycarbonate modified with a heterogeneous metal according to a non-limiting embodiment of the disclosure may have a pore size distribution having a pore diameter peak of less than or equal to about 10 nm. For example, the yttrium hydroxycarbonate modified with a heterogeneous metal may have a pore size distribution having a pore diameter peak of about 1 nm to about 7 nm. In another instance, the yttrium hydroxycarbonate modified with a heterogeneous metal may have a pore size distribution having a pore diameter peak of about 2 nm to about 6 nm. According to another non-limiting embodiment, the yttrium hydroxycarbonate modified with a heterogeneous metal may have a pore size distribution having a pore diameter peak of about 3 nm to about 4 nm. The pore size refers to a diameter of a pore in the case of a spherical shape. Alternatively, in the case of a shape other than a spherical shape, the pore size means the length of a longitudinal axis of the pore. With the pore size distribution according to example embodiments, the adsorption capacity for a heavy metal may be improved.

With regard to a yttrium hydroxycarbonate modified with a heterogeneous metal, the yttrium hydroxycarbonate may be a yttrium basic carbonate (Y(OH)CO₃).

With a pore size of less than or equal to about 10 nm, the specific surface area of the yttrium hydroxycarbonate modified with a heterogeneous metal may be improved. According to a non-limiting embodiment, the yttrium hydroxycarbonate modified with a heterogeneous metal may have a specific surface area of about 20 m²/g to about 260 m²/g. According to another non-limiting embodiment, the yttrium hydroxycarbonate modified with a heterogeneous metal may have a specific surface area of about 70 m²/g to about 260 m²/g. The increased specific surface area may expose more heavy metal adsorption sites existing on the surface. As a result, the greater number of exposed adsorption sites may improve the adsorption capacity for a heavy metal by the yttrium hydroxycarbonate modified with a heterogeneous metal.

According to a non-limiting embodiment, the yttrium hydroxycarbonate modified with a heterogeneous metal may have a pore volume ranging from about 0.1 cc/g to about 0.7 cc/g. According to another non-limiting embodiment, the yttrium hydroxycarbonate modified with a heterogeneous metal may have a pore volume ranging from about 0.2 cc/g to about 0.5 cc/g. With the pore volume of the above range, the yttrium hydroxycarbonate modified with a heterogeneous metal may have an improved adsorption capacity for a heavy metal. The heterogeneous metal is a metal other than yttrium (Y). For example, the heterogeneous metal may be selected from the group consisting of a transition element, a rare earth element, an alkali metal, an alkaline-earth metal, a Group 14 element, and a combination thereof. The transition element may be selected from the group consisting of titanium (Ti), vanadium (V), manganese (Mn), chromium (Cr), iron (Fe), cobalt (Co), nickel (Ni), and a combination thereof. The alkali metal and the alkaline-earth metal may be selected from the group consisting of calcium (Ca), magnesium (Mg), and a combination thereof. The Group 14 element may be silicon (Si).

According to a non-limiting embodiment, the heterogeneous metal may be included in an amount of about 0.1 wt % to about 20 wt % based on the total amount of the yttrium hydroxycarbonate modified with a heterogeneous metal. According to another non-limiting embodiment, the heterogeneous metal may be included in an amount of about 0.5 wt % to about 12.5 wt %. As a result of the disclosed ranges, when the structure of the yttrium hydroxycarbonate contains the heterogeneous metal, the structure of the yttrium hydroxycarbonate may be effectively modified while not deteriorating the physical properties of the yttrium hydroxycarbonate.

The heterogeneous metal may exist in the form of a heterogeneous metal oxide (MOₓ) in the structure of the yttrium hydroxycarbonate, where M is a heterogeneous metal and x is determined based on the valence of M.

The adsorption capacity for a heavy metal may be improved by modifying the structure of a yttrium hydroxycarbonate with a heterogeneous metal. In other words, whereas unmodified yttrium hydroxycarbonate has a spherical shape of about 120 nm to about 160 nm, yttrium hydroxycarbonate modified with a heterogeneous metal has an irregular, shapeless structure. The shapeless form includes particles of an average particle diameter of about 10 nm to about 30 nm. The shapeless structure includes particles of an average particle diameter of a range that may improve the adsorption capacity of the yttrium hydroxycarbonate modified with a heterogeneous metal.

Also, according to a non-limiting embodiment, the shapeless irregular structure includes pores having an average pore size of about 5 nm to about 200 nm. According to another non-limiting embodiment, the shapeless irregular structure includes pores having an average pore size of about 10 nm to about 150 nm. According to yet another non-limiting embodiment, the shapeless irregular structure includes pores having an average pore size of about 15 nm to about 50 nm. Herein, the pore size means the diameter of a pore (in the case of spherically-shaped pores) or the length of the longest axis of a pore (in the case of irregularly-shaped pores). The shapeless structure including pores of an average pore size of the range may improve the adsorption capacity of the yttrium hydroxycarbonate modified with a heterogeneous metal.

Also, the yttrium hydroxycarbonate modified with a heterogeneous metal has an amorphous structure.

Since the yttrium hydroxycarbonate modified with a heterogeneous metal has the disclosed surface area and pore size, it may be used as an adsorbent for a heavy metal. As a result, one or more heavy metals may be removed from a water source to produce potable water. When the heavy metal is arsenic (As), the adsorption mechanism of the yttrium hydroxycarbonate modified with a heterogeneous metal is as shown in the following Reaction Scheme 1.

pH 7.5 to 9.0: M-Y(OH)CO₃+HAsO₄²⁻→M-Y(OH)AsO₄+CO₃²⁻

pH 9.8 to 10.5: M-Y(OH)CO₃+2H₂AsO₃⁻→M-Y(OH) (H₂AsO₃)₂+CO₃²⁻

pH 3.5 to 6.5: M-Y(OH)CO₃+3H₂AsO₄⁻→M-Y (H₂AsO₄)₃+CO₃²⁻+OH⁻ [Reaction Scheme 1]

In Reaction Scheme 1, M denotes a heterogeneous metal.

As shown in Reaction Scheme 1, arsenic (As) is removed from water through the chemical adsorption at about pH 7.5 or higher, and at about pH 6.5 or lower, through both chemical adsorption and a precipitation reaction that occurs due to the partial dissolution of M-Y(OH)CO₃.

Since the yttrium hydroxycarbonate modified with a heterogeneous metal has improved heavy metal adsorption/removal performance, it may provide potable water by selectively adsorbing/removing heavy metal ions existing in water while maintaining minerals in the water.

The yttrium hydroxycarbonate modified with a heterogeneous metal may be prepared by performing a co-precipitation reaction on a yttrium-containing salt and a heterogeneous metal-containing salt. In short, the yttrium hydroxycarbonate modified with a heterogeneous metal may be prepared by preparing an aqueous solution including a yttrium-containing salt and a heterogeneous metal-containing salt, adding urea to the aqueous solution to prepare a mixture, controlling the pH of the mixture to about 6 to about 8 to facilitate precipitation, and drying the precipitate.

The heterogeneous metal of the heterogeneous metal-containing salt refers to a metal other than yttrium (Y). For example, the heterogeneous metal-containing salt may be a salt containing a heterogeneous metal which is selected from the group consisting of a transition element, a rare earth element, an alkali metal, an alkaline-earth metal, a Group 14 element, and a combination thereof. The transition element may be selected from the group consisting of titanium (Ti), vanadium (V), manganese (Mn), chromium (Cr), iron (Fe), cobalt (Co), nickel (Ni), and a combination thereof. The alkali metal and the alkaline-earth metal may be selected from the group consisting of calcium (Ca), magnesium (Mg), and a combination thereof. The Group 14 element may be silicon (Si).

The forms of the yttrium-containing salt and the heterogeneous metal-containing salt are not limited to specific forms. For instance, a chlorate, a sulfate, a nitrate, and a halide (e.g., chloride) may be used. When the yttrium hydroxycarbonate is modified with two or more heterogeneous metals, two or more kinds of heterogeneous metal-containing salts may be mixed and used. Alternatively, a composite metal salt containing two or more heterogeneous metals may be used. The appropriate form of salt may be selected according to the kind of the heterogeneous metal.

The pH may be controlled by adding a basic solution, but is not limited thereto. Non-limiting examples of the basic solution may include an alkali metal salt solution with a pH of about 9 to 14, an alkaline-earth metal salt solution, a transition element salt solution, ammonium hydroxide, and an ammonium salt solution. According to a non-limiting embodiment, the basic solution may have a concentration of about 0.01 M to about 2 M. According to another non-limiting embodiment, the basic solution may have a concentration of about 0.1 M to about 1.5 M. Non-limiting examples of the basic solution may include a LiOH solution, a NaOH solution, a KOH solution, a NaHCO₃ solution, a Na₂CO₃ solution, a Ca(OH)₂ solution, a Cu(OH)₂ solution, a Fe(OH)₂ solution, an ammonium hydroxide solution, a tetramethylammonium hydroxide solution, a tetrabutylammonium hydroxide solution, and the like.

The process of drying the precipitate may be performed at about 80° C. to about 200° C.

The yttrium hydroxycarbonate modified with a heterogeneous metal may be applied to a filter device of a water purifier as an adsorbent.

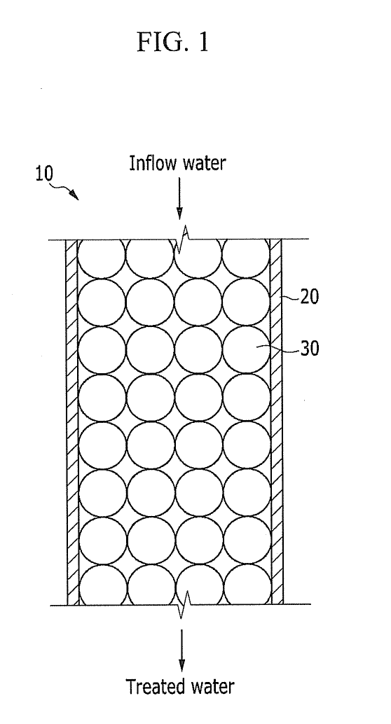

FIG. 1 is a schematic diagram of a filter device 10 according to a non-limiting embodiment of the disclosure. Referring to FIG. 1, the filter device 10 includes an adsorbent 30 filling a case 20.

The adsorbent 30 adsorbs heavy metals or chlorine sterilization byproducts that exist in the water. In a non-limiting embodiment, the adsorbent 30 is an yttrium hydroxycarbonate modified with a heterogeneous metal that may adsorb arsenic existing in the water in the form of trivalent or pentavalent oxyanion, such as H₃AsO₃, H₂AsO₄⁻, and HAsO₄²⁻. Although FIG. 1 shows a situation where the adsorbent 30 fills the case 20, example embodiments are not limited thereto. For instance, the adsorbent 30 may coat the interior wall of the case 20 in the form of nanoparticles. Alternatively, the adsorbent 30 may be deposited on the inner walls of the case 20 in the form of a thin film.

Hereinafter, various embodiments are illustrated in more detail with reference to the following examples. However, it should be understood that the following are non-limiting example embodiments.

### COMPARATIVE EXAMPLE 1

### Preparation of Y(OH)CO₃

A mixture is prepared by mixing 50 ml of 0.2 M yttrium chloride (YCl₃) and 400 ml of 0.5 M urea, and the pH of the mixture is controlled to 6.5 by adding 0.1 M NaOH. A precipitate is formed by heating the mixture on a heating plate at 95° C. for 1 hour. Y(OH)CO₃ is prepared by cleaning the precipitate with distilled water and drying it in a drying oven at 105° C. for 24 hours.

### COMPARATIVE EXAMPLE 1

### Preparation of TiO₂

A mixture is prepared by mixing 50 ml of 0.2 M Ti₂(SO₄)₃ with 400 ml of urea, and the pH of the mixture is controlled to 6.5. A precipitate is formed by heating the mixture on a heating plate at 95° C. for 1 hour. TiO₂ (anatase) is prepared by cleaning the precipitate with distilled water and drying it in a drying oven at 105° C. for 24 hours.

### EXAMPLE 1

### Preparation of Ti-Modified Y(OH)CO₃

A mixture is prepared by mixing 40 ml of 0.2 M yttrium chloride (YCl₃) and 10 ml of 0.2 M Ti₂(SO₄)₃, and the pH of the mixture is controlled to 6.5 by adding 0.1 M NaOH. A precipitate is formed by heating the mixture on a heating plate at 95° C. for 1 hour. Ti-modified Y(OH)CO₃ is prepared by cleaning the precipitate with distilled water and drying it in a drying oven at 105° C. for 24 hours.

### EXAMPLE 2

### Preparation of Ti-Modified Y(OH)CO₃

A mixture is prepared by mixing 30 ml of 0.2 M yttrium chloride (YCl₃) and 20 ml of 0.2 M Ti₂(SO₄)₃, and the pH of the mixture is controlled to 6.5 by adding 0.1 M NaOH. A precipitate is formed by heating the mixture on a heating plate at 95° C. for 1 hour. Ti-modified Y(OH)CO₃ is prepared by cleaning the precipitate with distilled water and drying it in a drying oven at 105° C. for 24 hours.

Morphology Analysis

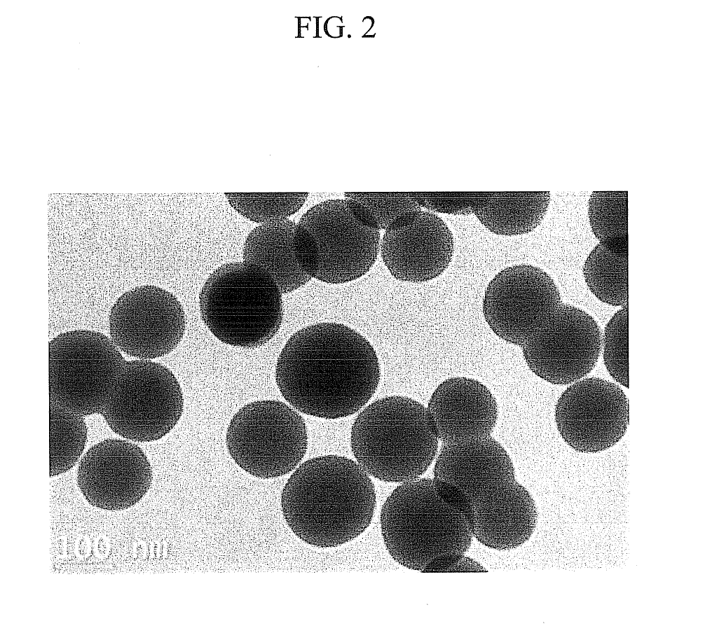

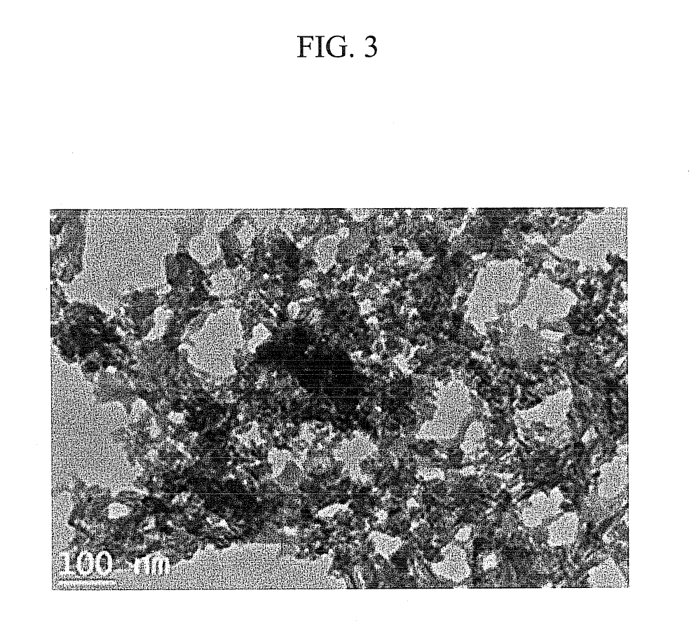

FIG. 2 is a transmission electron microscopic (TEM) photograph of the Y(OH)CO₃ prepared according to Comparative Example 1. FIG. 3 is a transmission electron microscopic (TEM) photograph of the Ti-modified Y(OH)CO₃ prepared according to Example 2.

As shown in FIG. 2, the Y(OH)CO₃ of Comparative Example 1 has a globular shape with a size of about 120 to about 160 nm. On the other hand, as shown in FIG. 3, the Ti-modified Y(OH)CO₃ of Example 2 has a relatively small particle size of about 10 to about 30 nm, and the morphology is shapeless.

BET Surface Area, Average Pore Size, and Pore Volume

The BET surface areas of the Y(OH)CO₃ prepared according to Comparative Example 1, the TiO₂ (anatase) prepared according to Comparative Example 2, and the Ti-modified Y(OH)CO₃ prepared according to Examples 1 and 2 are measured and are presented in the following Table 1. Also, the average pore size and pore volume of the Y(OH)CO₃ prepared according to Comparative Example 1, the TiO₂ (anatase) prepared according to Comparative Example 2, and the Ti-modified Y(OH)CO₃ prepared according to Examples 1 and 2 are measured and are presented in the following Table 1. The average pores sizes are obtained by analyzing the result values of a N₂ adsorption/desorption isotherm at 77 K based on a BET method, and the pore volumes are obtained from the result values of a N₂ adsorption/desorption isotherm at 77 K and BJH desorption.

Arsenic Adsorption

0.05 g of the Y(OH)CO₃ prepared according to Comparative Example 1, 0.05 g of the TiO₂ (anatase) prepared according to Comparative Example 2, and 0.05 g of the Ti-modified Y(OH)CO₃ prepared according to Examples 1 and 2 are reacted with 50 ml of arsenic solution (pH: 7) having an initial concentration of 1000 mg/L at 25° C. for 24 hours. Subsequently, the solution is filtrated and then the arsenic variation of the solution is analyzed using ICP-OES (inductively coupled plasma-optical emission spectroscopy). The results are presented in the following Table 1.

TABLE 1

| | Comparative | Comparative | | |
|---|---|---|---|---|
| | Example 1 | Example 2 | Example 1 | Example 2 |
| BET surface area | 1 | 261 | 82 | 168 |
| (m²/g) | | | | |
| Average pore size | 8.7 | 3.1 | 16.3 | 8.5 |
| (nm) | | | | |
| Pore volume (cc/g) | 0.01 | 0.19 | 0.39 | 0.50 |
| As adsorption | 246 | 3 | 332 | 328 |
| amount (mg/g) | | | | |

Referring to Table 1, although the Y(OH)CO₃ of Comparative Example 1 has a specific surface area as small as 1 m²/g, the Ti-modified Y(OH)CO₃ of Examples 1 and 2 respectively have a specific surface area as great as 82 m²/g and 168 m²/g.

To evaluate the As adsorption amount, the Y(OH)CO₃ of Comparative Example 1 has an adsorption amount of 246 mg/g, while the Ti-modified Y(OH)CO₃ of Examples 1 and 2 have an improved As adsorption amount of 332 mg/g and 328 mg/g, respectively, compared with the Y(OH)CO₃ of Comparative Example 1. On the other hand, the TiO₂ (anatase) of Comparative Example 2 has a relatively large specific surface area but has a relatively small As adsorption amount of 3 mg/g. This is because a new pore structure is formed in Y(OH)CO₃ as Ti is co-precipitated in a conventional Y(OH)CO₃ having a relatively small specific surface area.

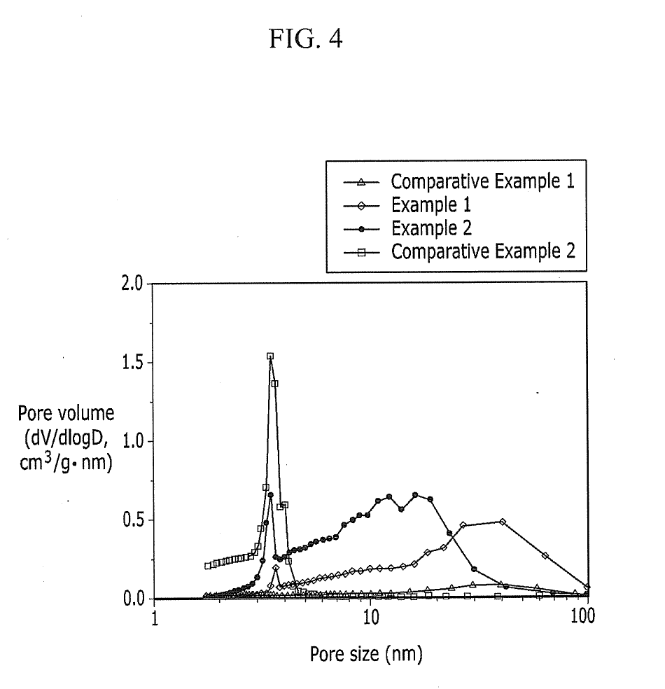

The pore structures of the Y(OH)CO₃ prepared according to Comparative Example 1, the TiO₂ (anatase) prepared according to Comparative Example 2, and the Ti-modified Y(OH)CO₃ prepared according to Examples 1 and 2 are analyzed and are presented in FIG. 4. Referring to the results of FIG. 4, whereas the Y(OH)CO₃ prepared according to Comparative Example 1 has relatively few pores, the TiO₂ (anatase) prepared according to Comparative Example 2 has a greater volume of pores at a size of about 3.5 nm. On the other hand, the Ti-modified Y(OH)CO₃ prepared according to Examples 1 and 2 has an improved pore size distribution of about 3.5 nm. It may be seen from the fact that Ti exists in the form of TiO₂ (anatase) and pores of about a 3.5 nm size that are similar to the TiO₂ (anatase) appear. Also, it may be seen that the Ti-modified Y(OH)CO₃ of Examples 1 and 2 have newly developed pores of about 5 nm to about 100 nm that are not shown in the single phases of the Y(OH)CO₃ of Comparative Example 1 and the TiO₂ (anatase) of Comparative Example 2. This is regarded as being because pores are newly generated in Y(OH)CO₃ as Ti is co-precipitated, and the new pores increase the specific surface area, compared with the Y(OH)CO₃ of Comparative Example 1, and produce sites for bonding with As. As a result, it is expected that the adsorption capacity of As (as well as other heavy metals) may be improved.

While various examples have been described herein, it should be understood that the disclosure is not limited to these embodiments. On the contrary, the disclosure is intended to cover all modifications and equivalent arrangements included within the spirit and scope of the appended claims.

<Description of Symbols>

| | |
|---|---|
| 10: filter device | 20: case |
| 30: adsorbent | |

What is claimed is:

1. A modified yttrium hydroxycarbonate, comprising:
a structural framework defining a plurality of pores therein, a size distribution of the plurality of pores having a peak of less than or equal to about 10 nm, the structural framework formed of at least yttrium atoms, oxygen atoms, and carbon atoms; and
a heterogeneous metal within the structural framework, the heterogeneous metal being a metal other than yttrium.

2. The modified yttrium hydroxycarbonate of claim 1, wherein the size distribution of the plurality of pores has a peak of about 1 nm to about 7 nm.

3. The modified yttrium hydroxycarbonate of claim 1, wherein the structural framework has a specific surface area of about 20 m²/g to about 260 m²/g.

4. The modified yttrium hydroxycarbonate of claim 3, wherein the specific surface area is about 80 m²/g to about 170 m²/g.

5. The modified yttrium hydroxycarbonate of claim 1, wherein a volume of the plurality of pores is about 0.1 cc/g to about 0.7 cc/g.

6. The modified yttrium hydroxycarbonate of claim 5, wherein the volume of the plurality of pores is about 0.35 cc/g to about 0.55 cc/g.

7. The modified yttrium hydroxycarbonate of claim 1, wherein the heterogeneous metal is selected from the group consisting of a transition element, a rare earth element, an alkali metal, an alkaline-earth metal, a Group 14 element, and a combination thereof.

8. The modified yttrium hydroxycarbonate of claim 7, wherein the heterogeneous metal is selected from the group consisting of titanium (Ti), vanadium (V), manganese (Mn), chromium (Cr), iron (Fe), cobalt (Co), nickel (Ni), calcium (Ca), magnesium (Mg), silicon (Si), and a combination thereof.

9. The modified yttrium hydroxycarbonate of claim 1, wherein the heterogeneous metal is a Period 4 metal.

10. The modified yttrium hydroxycarbonate of claim 1, wherein the heterogeneous metal is present in an amount of about 0.1 wt % to about 20 wt % based on a total weight of the modified yttrium hydroxycarbonate.

11. The modified yttrium hydroxycarbonate of claim 10, wherein the heterogeneous metal is included in the amount of about 0.5 wt % to about 12.5 wt % based on the total weight of the modified yttrium hydroxycarbonate.

12. The modified yttrium hydroxycarbonate of claim 1, wherein the heterogeneous metal exists in a form of a heterogeneous metal oxide (MOₓ) in the structural framework of the modified yttrium hydroxycarbonate, where M denotes the heterogeneous metal and x is a value determined based on the valence of M.

13. The modified yttrium hydroxycarbonate of claim 1, wherein an overall shape of the structural framework of the modified yttrium hydroxycarbonate is irregular and unsymmetrical.

14. The modified yttrium hydroxycarbonate of claim 1, wherein the structural framework includes particles having an average diameter of about 10 nm to about 30 nm.

15. The modified yttrium hydroxycarbonate of claim 1, wherein the plurality of pores have an average size of about 5 nm to about 200 nm.

16. The modified yttrium hydroxycarbonate of claim 15, wherein the average size of the plurality of pores is about 8 nm to about 20 nm.

17. An adsorbent for a heavy metal, comprising:
the modified yttrium hydroxycarbonate of claim 1.

18. The adsorbent of claim 17, wherein the modified yttrium hydroxycarbonate has an affinity for adsorbing arsenic.

19. The adsorbent of claim 17, wherein the modified yttrium hydroxycarbonate has a heavy metal adsorption capacity of greater than or equal to about 250 mg/g.

20. The adsorbent of claim 19, wherein the heavy metal adsorption capacity is greater than or equal to about 300 mg/g.

21. A method for preparing the modified yttrium hydroxycarbonate according to claim 1, comprising:
preparing an aqueous solution containing a yttrium-containing salt and a heterogeneous metal-containing salt;
preparing a mixture by adding urea to the aqueous solution;
controlling a pH of the mixture to about 6 to about 8 to obtain a precipitate; and
drying the precipitate.

22. The method of claim 21, wherein the heterogeneous metal-containing salt includes the heterogeneous metal, the heterogeneous metal being selected from the group consisting of a transition element, a rare earth element, an alkali metal, an alkaline-earth metal, a Group 14 element, and a combination thereof.

23. A filter device, comprising:
the modified yttrium hydroxycarbonate according to claim 1 as an adsorbent for a heavy metal.
